(19) United States
(12) Patent Application Publication
(10) Pub. No.: US 2024/0356179 A1
(43) Pub. Date: Oct. 24, 2024

(54) SECONDARY BATTERY ASSEMBLY

(71) Applicant: NORTHVOLT AB, Stockholm (SE)

(72) Inventors: Rodyn GILHARRY, Västerås (SE); Csaba DOBI, Västerås (SE); Daniela BOK, Västerås (SE); Sang EUN CHEON, Stockholm (SE)

(21) Appl. No.: 18/755,899

(22) Filed: Jun. 27, 2024

Related U.S. Application Data
(63) Continuation of application No. PCT/EP2022/087762, filed on Dec. 23, 2022.

(30) Foreign Application Priority Data
Dec. 27, 2021 (SE) 2151624-0

(51) Int. Cl. H01M 50/569; H01M 10/04; H01M 10/42; H01M 50/103; H01M 50/176; H01M 50/548; H01M 50/553

(52) U.S. Cl. CPC H01M 50/569; H01M 10/0468; H01M 10/0486; H01M 10/425; H01M 50/103; H01M 50/176; H01M 50/548; H01M 50/553

(57) ABSTRACT

An electrode plate assembly for a secondary battery module is disclosed, comprising a plurality of cells (100) arranged in a vertical stack (10). Each cell of the stack comprises a positive electrode plate (110), a negative electrode plate, and a separator. The separator is interposed between the positive electrode plate and the negative electrode plate and configured allow ions to move between the positive electrode plate and the negative electrode plate. The electrode plate assembly further comprises a plurality of contacting means (140) for electrical monitoring of the cells, wherein each of the plurality of contacting means is electrically connected to at least one of the positive and negative electrode plates of a respective one of the cells and arranged to protrude laterally from a side edge (101, 102, 103) of the cell. The contacting means are distributed spatially along a width (W) of the stack.

### TECHNICAL FIELD

The present disclosure relates to secondary battery assemblies, and more particularly to electrode plate assemblies comprising a plurality of cells arranged in a vertical stack.

### BACKGROUND

Rechargeable or secondary batteries find widespread use as electrical power supplies and energy storage systems. For example, in automobiles, battery packs formed of a plurality of battery modules, wherein each battery module includes a plurality of electrochemical cells, are provided as a means of effective utilization of electric power, also in the viewpoint of air pollution prevention. Several different form factors exist for the electrochemical cells applied in secondary batteries depending on their intended application field. In automotive applications, the most common cell types are cylindrical, prismatic and pouch cells. A further concept for automotive applications is large format flat, thin cells, which in general include a single positive electrode and a single negative electrode and in which the upper and lower surfaces are formed by the electrodes, which serve as cell housing and also act as the terminals for the cell. However, there is still a need for alternative and improved cell designs and battery packs, in particular in view of electrical monitoring of the cells and challenges relating to mechanical movement during cell swelling.

### DESCRIPTION OF THE INVENTIVE CONCEPT

According to a first aspect, a secondary battery module, or battery pack, comprising a plurality of cells arranged in a vertical stack is provided. Each of the cells of the stack comprises a positive electrode plate (also referred to as a positive electrode), a negative electrode plate (also referred to as a negative electrode) and a separator interposed between the positive electrode plate and the negative electrode plate. The separator is configured to allow ions to move between the positive electrode and the negative electrode. Thus, the positive electrode, the negative electrode and the separator may be arranged in a single positive electrode-separator-single negative electrode stack.

According to some embodiments the cells may be serially stacked on top of each other, such that the electrodes of two neighbouring cells are brought in electrical contact with each other. The electrical contact may for instance be achieved by a direct mechanical contact between adjacent cells, in which the bottom electrode of the upper cell is abutting the upper electrode of the lower cell. Alternatively, or additionally an intermediate layer may be provided between the cells to facilitate mechanical and/or electrical contact between the cells. The intermediate layer may for example comprise an electrically conductive adhesive.

According to some embodiments the positive electrode (that is, the cathode) may include a first foil substrate, which may be formed of a first electrically-conducive material, and a first active material layer disposed on an inward facing side of the first foil substrate (that is, a side facing the separator and the negative electrode of the cell). The first foil substrate may preferably be a metal foil substrate formed of a first electrically conductive material such as aluminium, without being limited thereto. The first active material layer preferably comprises a first active material selected from a lithiated metal oxide, and in particular from a lithium transition metal composite oxide, wherein the metal preferably includes one or more of nickel (Ni), cobalt (Co) and manganese (Mn). According to a preferred example, the positive electrode is formed of an aluminium foil and has an active material layer comprising a lithium transition metal composite oxide disposed on the inward facing side. In embodiments, the first electrically conductive material of the first foil substrate may be coated on one or both sides thereof with an oxidation-preventing metal, such as chromium. In further embodiments, a conductive material layer may additionally be disposed on an inward facing side of the first foil substrate, such that the conductive material layer is sandwiched between the first foil substrate and the first active material layer in order to enhance cell performance.

According to some embodiments the negative electrode (that is, the anode) may include a second foil substrate, which may be formed of a second electrically conducive material and a second active material layer disposed on an inward facing side thereof (that is, a side facing the separator and the positive electrode in the cell). The second foil substrate may preferably be a metal foil substrate formed of a second electrically conducive material such as copper or copper-clad aluminium, without being limited thereto. The second active material layer preferably comprises a second active material selected from graphite or silicon, or mixtures thereof. According to a preferred example, the negative electrode may be formed of a copper foil and has an active material layer comprising graphite disposed on the inward facing side. In embodiments, the second electrically conducive material of the second foil substrate can be coated on one or both sides thereof with an oxidation-preventing metal, such as chromium.

The outward facing sides of first and second foil substrates of the respective electrodes can act as the negative and positive cell terminals, respectively, and may be electrically and mechanically connected in series to neighbouring cells in the cells stack.

The positive and negative electrodes may be spaced apart from each other by the separator, which may comprise an electrically isolating and permeable material that isolates the positive electrode from the negative electrode to prevent electrical short-circuiting and allow ion, provided in an electrolyte, to pass therethrough. In an example, the separator may comprise a three-layer structure comprising for example a base film, including a polyolefin and a non-woven material, a ceramic layer coated on the base film, and a layer including polyvinylidenfluorid and acrylate binder coated on the ceramic layer. The separator may have a peripheral shape that conforms to the peripheral shape of the positive electrode and the negative electrode. Further, the separator may in some embodiments have the same dimensions as the positive and negative electrodes.

In addition, a sealing layer may be provided between a peripheral edge of the separator and a peripheral edge of the positive electrode. A sealing layer may further be disposed between a peripheral edge of the separator and a peripheral edge of the negative electrode. The sealing layer may be provided to prevent short-circuiting between the electrodes, bond the electrodes to each other and prevent any liquid electrolyte from escaping the cell.

In some embodiments, the separator has lesser dimensions than the dimensions of the positive electrode and the negative electrode so that a peripheral edge of the separator resides within peripheral edges of the positive and negative electrodes when the cell is view in a top plan view. A sealing layer may be provided between a peripheral edge of the positive electrode and a peripheral edge of the negative electrode such that the positive electrode is sealed to the negative electrode, and the sealing layer surrounds a periphery of the separator.

The present electrode plate assembly provides a relatively large format flat cell in which the top and bottom surfaces, facing away from the separator, may act as positive and negative terminals. This allows for the cells to be stacked serially, eliminating the need for busbars of complex terminal attachments between the cells. By arranging the cells in direct contact with each other, or indirect via an electrically conducting intermediate layer, a relatively large contact area can be utilised to reduce electrical resistance between the series connected cells.

According to a second aspect, the electrode plate assembly may comprise a plurality of contacting means for electrical monitoring of the cells. Each of the contacting means may be electrically connected to at least one of the positive and negative electrode plates of a respective one of the cells and arrange to protrude laterally from a side edge of the cell. The contacting means may be distributed spatially along a width of the stack to facilitate physical an electrical access to the contacting means, as will be discussed in further detail in the following.

The contacting means may be substantially plate shaped and may be understood as a flap or strip of electrically conductive material attached to or projecting from an electrode. The contacting means may also be referred to as a tab, or voltage pickup tab. The tabs may be attached to a peripheral portion of the electrode, for instance by welding, soldering or conductive adhesive, or formed from a portion of the electrode. Thus, the electrode plate may in some embodiments be cut, or formed into a shape allowing a protruding portion of the electrode to function as a contacting means.

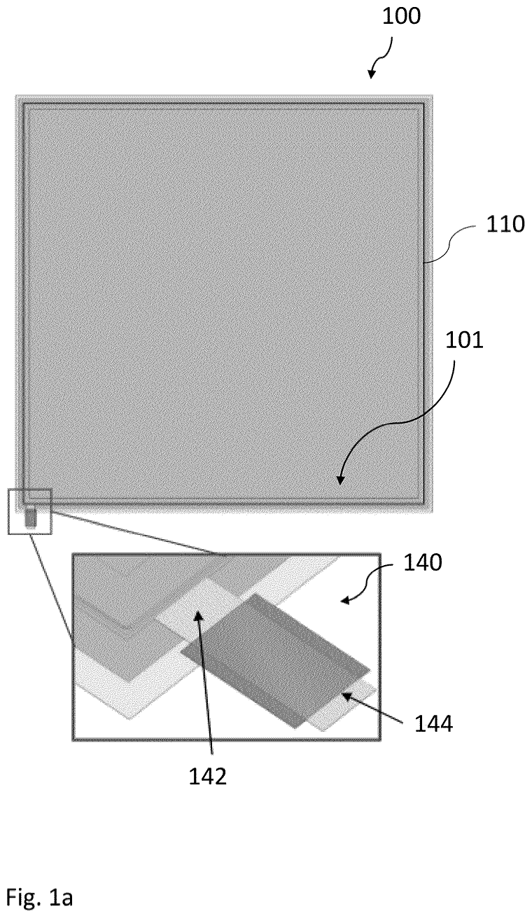

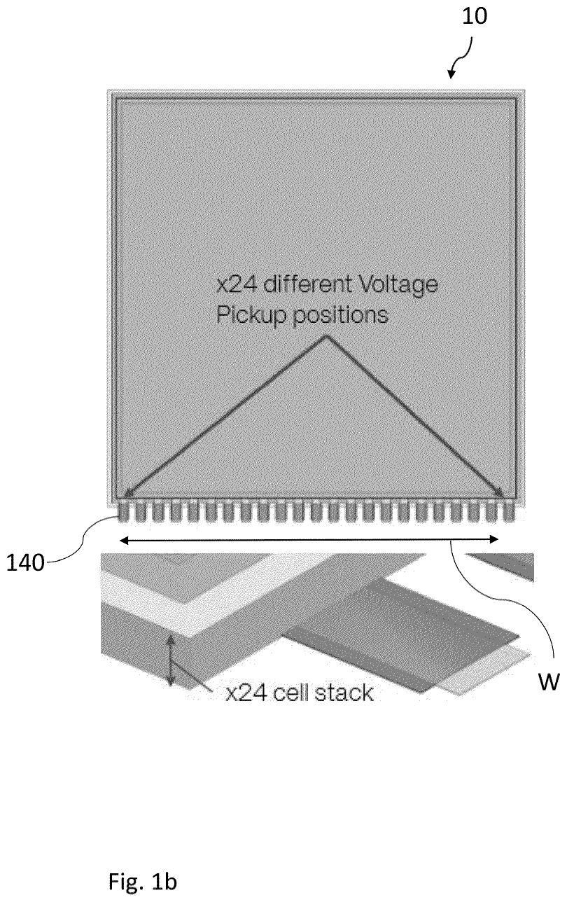

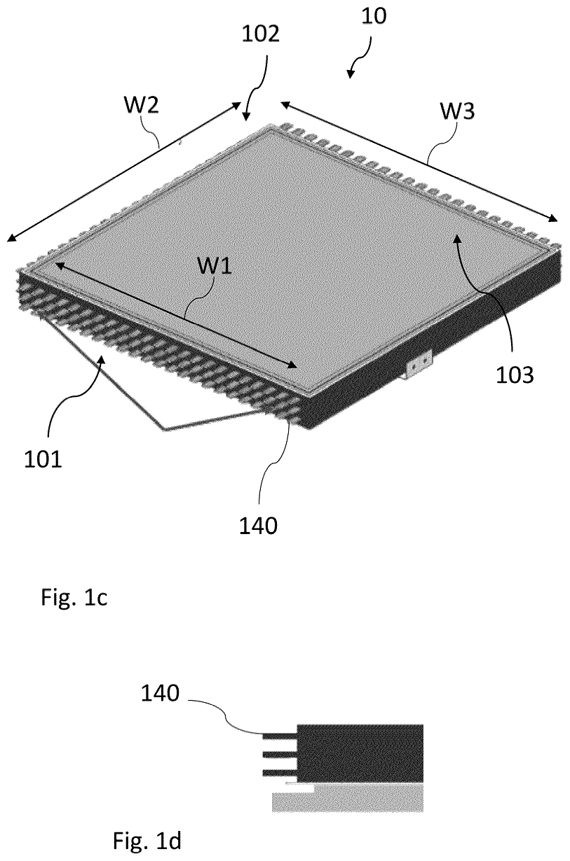

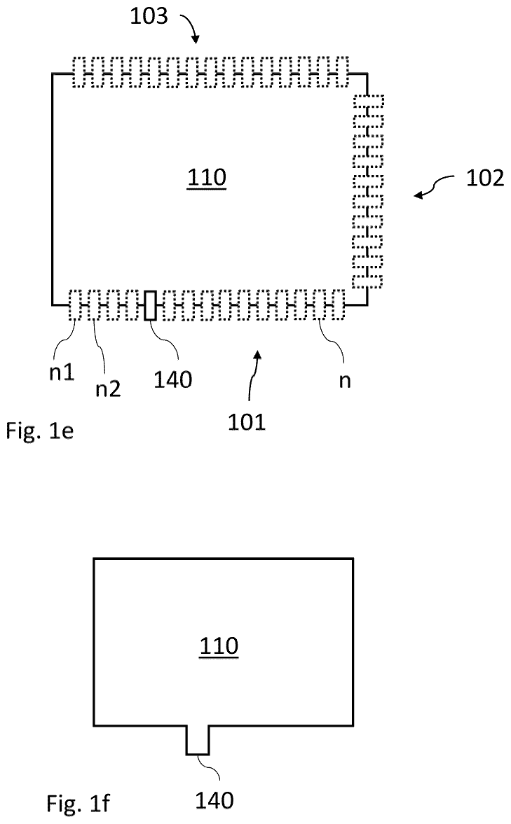

FIG. 1a is a top view of a single cell 100 according to an embodiment. The cell 100 comprises a positive electrode plate 110 arranged in a stack with a negative electrode plate 120 and a separator 130 (not shown), similar to what is described above in connection with the first aspect. A contacting means 140 is provided at a side edge 101 of the cell 100. In the present example, the contacting means 140 is electrically connected to the positive electrode plate 110 and arranged a first position along the side edge 102. As illustrated in the present figure, the contacting means 140 may be formed as a substantially plate shape, or tab shaped, element oriented in a plane parallel to the electrode plate 110 and protruding laterally from the side edge 102 to allow the contacting means 140 to be physically and electrically accessed.

The contacting means 140 may comprise a main portion 142 protruding from the cell 100, and a contacting portion 144 attached to the main portion 142 and configured to facilitate electrical access by e.g. a battery management system.

The contacting means 140 may be distributed spatially along a width W of the stack, as illustrated in FIG. 1b. FIG. 1b shows a vertical stack 10 of a plurality of cells 100, wherein a contacting means 140, such as a voltage pickup tab 140, is attached to each (or at least some) of the cells 100. The contacting means 140 may hence be arranged to protrude from the side edge 101 of the cells 100 at different positions along the width direction W. This allows for each of the contacting means 100 to be accessed from the side 101 of the cells 100 in a relatively easy manner also when a plurality of cells 100, such as 24 as shown in the present figures, are stacked on top of each other. In the present example, the contacting means 140 may be considered to be staggered with respect to each other along the vertical direction. In different words, the contacting means 140 of adjacent cells in the stack may be arranged so that they are not in line along the vertical direction. Stated differently, the contacting means 140 are spaced apart in the horizontal direction, i.e. along a width W of the stack, it being understood that “spaced apart” in this context does not exclude that a pair of contacting means 140 could partially overlap in the horizontal direction. In other words, the contacting means 140 are distributed spatially relative to each other; in a specific example, each adjacent pair of contacting means 140 are spaced apart in the horizontal direction relative to each other.

FIG. 1c shows a further example, in which 216 cells 100 are stacked in sets of 24, and wherein each set may be rotated by 0°, 90° and 180°, respectively. Each set of 24 may be similar to the stack disclosed in FIG. 1b and may hence comprise contacting means 140 that are substantially evenly distributed along the width direction W1. By rotating the sets 0°, 90° and 180° the contacting means 140 may be distributed over three side edges 101, 102, 103 of the stack. This allows for the contacting means 140 to be distributed over the width W1, W2, W3 of each side edges, as well as in the stacking direction, as indicated in FIG. 1d.

FIG. 1d is a cross section of a portion of the stack in FIG. 1c, showing vertically aligned contacting means 140 from three different sets of cells that are stacked on top of each other.

FIG. 1e illustrates an example of the distribution of contacting means 140 over the side edges 101, 102, 103 of an electrode plate 110. The contacting means 140 may be formed by an integral portion of the electrode plate 110, such as a portion of the foil substrate not covered with any active material layer, or by a separate contacting member which has been attached to a contacting portion of the electrode plate 110. As illustrated in the present figures, a plurality of positions n for the contacting means 140 may be defined along the width of the side edges 101, 102, 103. The positions n, in which the contacting means 140 may be arranged, are indicated by dotted lines in the present figure, whereas the actual contacting means 140 is indicated by a full line. The positions n may thus be considered to represent different available “slots” for the contacting means 140, which may varied in the stack in order to ensure a spatial distribution of the of the contacting means 140 along the sides of the stack. A first one of the cells may for instance comprise a contacting means 140 arranged at position n1, whereas the adjacent or neighbouring cell of the stack may comprise a contacting means 140 arranged at position n2, etcetera. In the present example, there are 15 positions available at the first side 101, 10 positions available at the second side 102 and 15 positions available at the third side 103 of the stack. This means that the stack may comprise 45 consecutive cells, of which each may have a contacting means 140 arranged at a unique position n along the side edges 101, 102, 103. This may be understood as the 45 contacting means 140 being staggered in the vertical direction. The 46^{th} cell of the stack, arranged adjacent to the 45^{th} cell, may have a contacting means 140 arranged at the first position n1. The contacting means 140 of the 46^{th} cell may hence be vertically aligned with the contacting means 140 of the first cell of the stack but separated in the vertical direction by the 45 layers of intermediate cells. The contacting means 140 of the first cell and the 46^{th} cell may therefore be considered as distributed in the vertical direction, thereby facilitating individual access to the respective contacting means 140.

FIG. 1f illustrates an example wherein the contacting means 140 is formed of a portion of the electrode plate 110. Hence, as referred to above, the tab 140 may be formed directly from the metal foil 110, preferably as the metal foil 110 is cut or otherwise given its final shape. This advantageously allows for a reduction in the number of steps required for the assembly process, since there is no need for additional steps of attaching or soldering contacting means, formed of separate elements, onto the electrode plate 110.

It will be appreciated that the above-disclosed configurations are merely exemplary embodiments illustrating a possible implementation of the inventive concept. Other configurations and distributions of the contacting means 140 are however conceivable. Further, it will be appreciated that each of the cells may not necessarily be connected to a respective contacting means 140. On the contrary, the contacting means may in some embodiments be connected to a subset of cells, such as to every second or third cell of the stack.

According to some embodiments, the electrode plate assembly may comprise access points instead of the contacting means as discussed above with reference to FIGS. 1a-f. The access points may be distributed in a similar way as the above-mentioned contacting means, that is, spatially along a width (and/or stacking direction) of the stack. The access points may however differ from the contacting means in that they are formed by regions or portions of the positive or negative electrode, or any intermediate structure attached to the positive or negative electrode.

According to some embodiments, the electrode plate assembly may comprise a plurality of sensors configured to be coupled to a respective contacting means or access point. The sensor may for example be connected to the access point by means of an electrical lead, by a contacting means, or be attached directly to the electrode.

The electrode plate assembly may further comprise a plurality of wireless transmitters, wherein each of the transmitters is configured to receive a signal from one or several of the sensors and transmit the signal to an external receiver. The sensor may be configured to generate a signal that is indicative of an operation parameter of one or several cells of the stack. The operational parameter may for example relate to a current, voltage or temperature of the cell.

According to an embodiment, the electrode plate assembly, or battery pack, may comprise a side frame part configured to be arranged at a side of the stack. The side frame part may comprise a plurality of slots, wherein each of the slots may be configured to receive a respective contacting means as the side frame part is being arranged at the side of the stack. The side frame part may form a part of a modular side frame assembly, comprising two or more parts which can be assembled into a frame at least partly enclosing the sides of the stack.

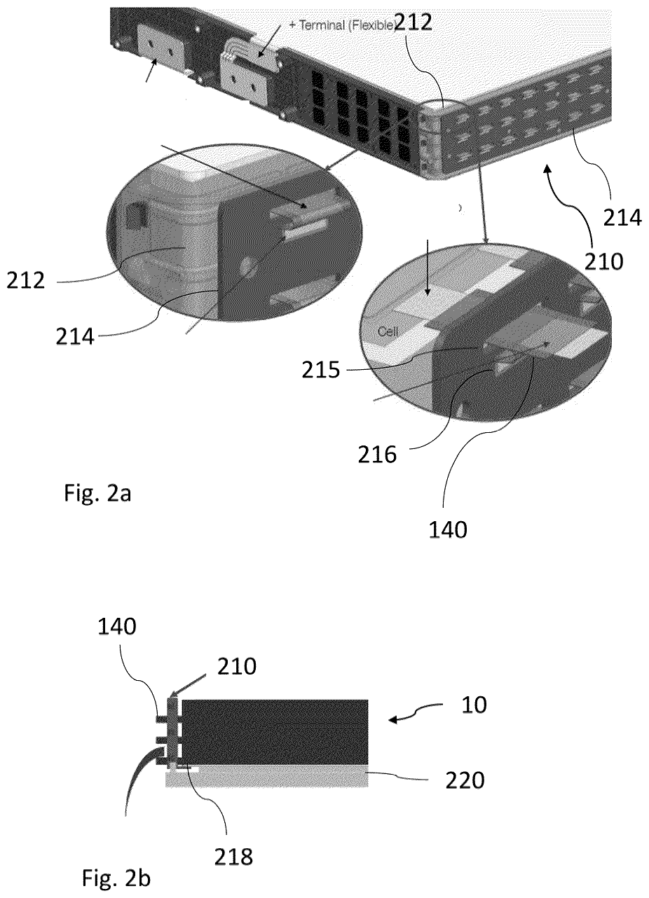

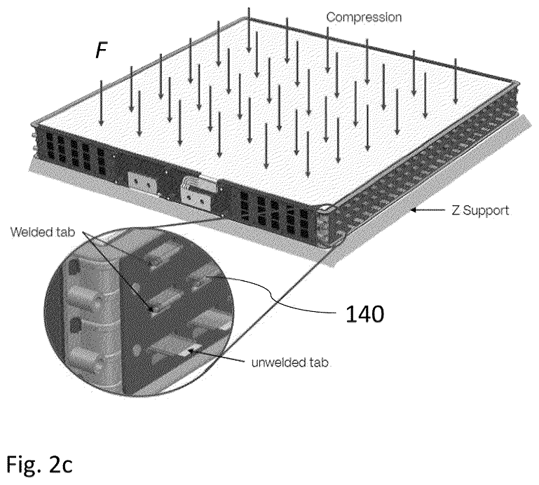

FIG. 2a illustrates an example of a side frame part 210, configured to be arranged at a side of the stack and fitted with further frame parts to form a casing or frame enclosing the sides of the stack. The side frame part 210 may comprise a mechanically stabilising first part 212 and a second part 214 for providing electrical connection of the protruding contacting means 140. The second part 214 may for example be a printed circuit board, PCB, comprising contact pads 216 to which the contacting means 140 may be mounted, for example by soldering, welding or electrically conductive adhesive. The mechanically stabilising first part 212 may be arranged between the stack and the second part 214, and the contact pads 216 may be arranged on a side of the second part 214 facing away from the stack. It will however be appreciated that the configuration in FIG. 2a is merely an example, and that the side frame part 210 may be configured differently. For example, the side frame part 210 need not necessarily comprise the first part 212 and the second part 214. Instead, the side frame part 210 may as well be formed from a single piece, having contact pads 216 or contact points 216 to which the contacting means 140 may be attached.

As illustrated in the present figure, the side frame part 210 may comprise a plurality of slits, or through-holes 215, configured to receive a respective contacting means 140 as the side frame part 210 is being arranged at the side of the stack. Thus, the slits 215 may have a shape corresponding to a cross sectional shape of the contacting means 140 to allow the contacting means 140 to extend through the side frame part 210 and be attached to the outer side of the side frame 210, i.e., the side of the side frame facing away from the stack. The slits 215 may hence be distributed spatially along a length direction of the side frame part 210 in a similar way as the contacting means 140 are distributed over the side of the stack.

The contacting means 140, or tabs 140, may be arranged to extend through the slits 215 and then be folded to contact the contact points, or contact pads 216, of the side frame part 210. FIG. 2a illustrates a tab both in its unfolded state, in which it is oriented in a plane parallel to the main plane of extension of the electrodes, and in a folded state in which it abuts the contact point 216 of the side frame part 210.

The slits 215 may be slightly larger than the cross section of the corresponding contacting means 140, extending therethrough, to provide some margin or tolerance for a relative movement between the contacting means 140 and the side frame part 210. The tolerance may facilitate the assembly process, reducing the requirements on alignment precision. Further, the tolerance may be introduced to address relative movement during operation of the battery pack. In particular, the height of the slits 215 (as measured along the stacking direction) may be larger than a thickness of the contacting means 140 to allow the contacting means to move along the stacking direction during swelling of the cells.

FIG. 2b is a cross section of a portion of the stack 10, showing a side frame part 210 arranged at the side of the stack 10 such that the contacting means 140 protrude through the side frame part 210. The side frame part 210 may for example be formed of a plastic material and may in some examples comprise a PCB (not shown) attached to the side of the side frame part 210 facing away from the stack 10. The side frame part 210 may be attached to the stack 10 by means of fastening pins 218 engaging a support fixture, or base plate 220 arranged below the stack 10. The side frame part 210 further be snap-fitted to further side frame parts 210 arranged at other sides of the stack to form a casing or frame enclosing the stack 10. The other side frame parts may be configured to electrically connect contacting means 140 protruding from the sides of the stack, or comprise terminal means for electrical connection of the battery pack. Further, it will be appreciated that the side frame parts may comprise further electronic components relating to e.g. monitoring of the battery cells and transmission of information associated with a status or performance of the cells. Thus, the side frame, which may be referred to as a modular side frame due to the interlocking character of the individual side frame parts, may be provide both mechanical support and protection of the stack 10, as well as monitoring and communication capabilities.

FIG. 2c schematically illustrate that compressive forces F may be applied to the stack in the stacking direction during the assembly process to compress the cells and thereby allow the contacting means, or tabs 140, to be arranged at their nominal positions (in the stacking direction) before they are attached to the contact points 216 on the frame parts. Put differently, the stack may be compressed in the stacking direction to align the contacting means 140 vertically prior to welding.

A plurality of cells arranged in a vertical stack, such as the stack described above with reference to the first and second aspect, may be subject to expansion due to cell swelling. As multiple cells are stacked to increase voltage, the cell swelling over the stack may result in a relatively large mechanical movement or expansion in the stacking direction. The swelling may be challenging for the designers of the battery pack, as the swelling may cause problems relating to the electrical as well as mechanical performance of the battery pack, as will be exemplified in the following.

According to a third aspect, an electrode plate assembly for a secondary battery module is provided, comprising a plurality of cells arranged in a vertical stack. The stack may be similarly configured as the stack discussed above in connection with the first and second aspect. Hence, each of the cells of the stack comprises a positive electrode plate, a negative electrode plate and a separator, wherein the separator is interposed between the positive electrode plate and the negative electrode plate and configured to allow ions to move between the positive and negative electrode plate. Further, neighbouring or adjacent cells of the stack are arranged such that the positive electrode plate of a first one of the neighbouring cells is contacting the negative electrode plate of the other one of the neighbouring cells, thereby allowing for the cells of the stack to be series connected along the stacking direction.

According to the present aspect, the electrode plate assembly may further comprise a top terminal plate, which is arranged above the stack and in electrical contact with a top one of the cells, a bottom terminal plate arrange below the stack and in electrical contact with a bottom one of the cells, and a housing configured to accommodate the bottom terminal plate, the stack, and the top terminal. The housing comprises a base plate and a top cover configured to be attached to each other to form the housing. Further, an elastic means may be arranged between the top cover and the top terminal to exert a compressing force on the stack in the stacking directions.

A merit of the present aspect is that the housing may allow for an improved cooling of the stack. The improved cooling may be achieved at least partly due to the relatively large surface-to-volume of the housing, facilitating heat dissipation from outer surfaces of the housing.

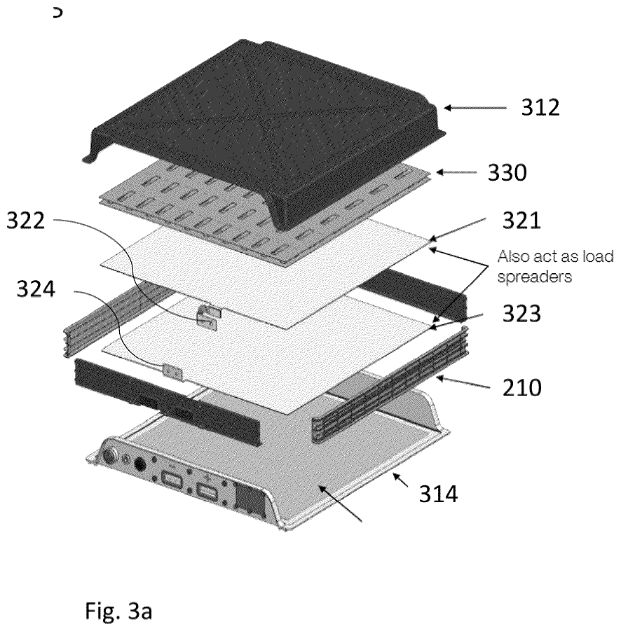

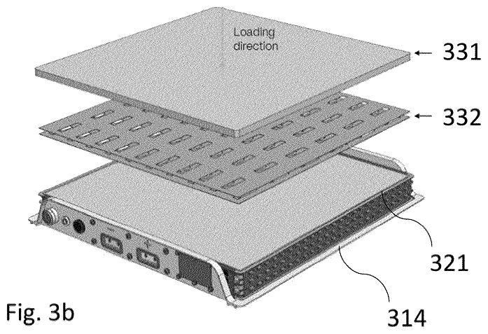

An example of such a housing is disclosed in FIG. 3a, formed by a base plate 314 and a top cover 312. The base plate 314 and the top cover 312 may be configured to be assembled into the housing, wherein the base plate 314 in the present example forms a bottom and two of the sidewalls of the housing, and the top cover 312 forms the top and the remaining sidewalls of the housing. The top cover 312 may be mechanically attached and sealed to the base plate by means of a rim portion extending along the periphery of the base plate and top cover, respectively. The attachment may for example be achieved by means of rivets. Preferably, the base plate 314 is relatively rigid and form stable to provide mechanical support to the stack and reduce the risk of deformation of the stack.

FIG. 3a further illustrates a bottom terminal plate 323, which may be configured to be arranged below the stack (not shown in FIG. 3a), and a top terminal plate 321 configured to be arrange above the stack. The terminal plates 321, 323 may have a similar shape as the electrodes plates of the cells to provide a relatively large contact area and to distribute any contacting forces over an as large area of the cells as possible. Each of the terminal plates 321, 323 may further comprise a respective terminal contact 322, 324, or busbar, which may be configured to be arranged at one of the sides of the stack.

The battery pack of FIG. 3a may also comprise a frame structure assembled from a plurality of side frame parts 210, which may be similarly configured as the side frame parts 210 discussed above with reference to e.g. FIGS. 2a-c. In the present example, three of the side frame parts 210 may be configured to receive the tab-shaped contacting means 140, whereas the fourth one of the side frame parts 210 may be configured to receive or support, inter alia, the terminal contacts 322, 324. The frame structure may thus provide both mechanical support of the stack as well as electrical access to the cells for battery monitoring functions.

As will be discussed in further detail below, the top terminal contact 322 may be connected to the top terminal plate 321 by means of a flexible busbar allowing the top terminal plate to move relative to the side frame part, to which the terminal contact 322 is attached.

The battery pack may further comprise an elastic means 330 configured to be arranged between the top cover 312 and the top terminal plate 321. The elastic means 330 may be biased between the top cover 312 and the top terminal plate 321 in order to exert a compressing force on the stack, along the stacking direction. The compressing force may be provided to improve the electrical contact between the series connected cells. Further, since the elastic means 330 is elastic, it is capable of maintaining a compressive force on the stack also during swelling and shrinking of the stack. Put differently, the elastic means 330 is configured to deform as the top terminal plate moves along the stacking direction, thereby absorbing the movement while maintaining a compression of the stack.

The elastic means 330 may be substantially plate-shaped, having a shape and size corresponding to the lateral size and shape of the stack to allow a substantially uniform load distribution over the cells. The elastic means 330 may thus be referred to as a compression plate and may for instance comprise a spring plate as illustrated in FIG. 3a or a pad of an elastic material, such as a foam pad.

FIG. 3b shows two different examples of compression plates, wherein the first one is a foam pad 331, such as a silicone foam pad, and the second one is a spring plate 332 comprising two parallel plates that are joined to each other by means of a plurality of spring elements. By any of these arrangements the cell stack may be biased in the stacking direction to ensure compression of the cells also when there is a movement or swelling in the stacking direction. Thus, a relatively constant and even compression, or contact pressure between adjacent cells may be achieved as the stack expands and contracts along the stacking direction. Further, the compression allows for any intermediate layers, such as cell sealants and conductive adhesives between adjacent cells, to be relatively evenly distributed or spread over the contact surfaces. Especially during assembly when a compressing force may be applied to spread the intermediate layer. The present aspect therefore has the merits of maintaining a compression of the stack also when there is a relatively large mechanical movement or expansion in the stacking direction.

According to a fourth aspect, an electrode plate assembly is provided, which may be similarly configured as the electrode plate assembly according to the first aspect, with the addition of a top terminal plate arranged above the stack and in electrical contact with a top one of the cells, a top terminal contact, and a flexible busbar arranged to electrically connect the top terminal plate. The flexible busbar is further configured to allow the top terminal plate to move relative the top terminal contact in response to the stack moving, or expanding and contracting, in the stacking direction. The terminal plates, the terminal contacts and the flexible busbar may be similarly configured as the embodiments discussed above with reference to FIG. 3a. The present aspect hence aims at addressing challenges associated electrical contact of the stack as the stack is subject to swelling.

Further, it will be appreciated that the terminal plates and/or the busbar may serve the additional purpose of dissipating heat from the electrode plate assembly. Thus, the present aspect is advantageous in that it may allow for an improved cooling of the stack.

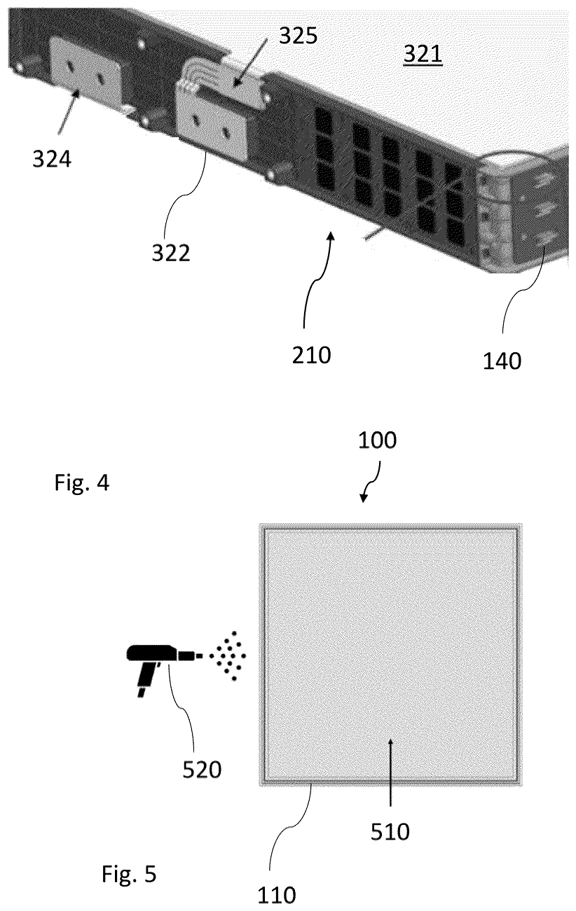

FIG. 4 is a perspective view of a portion of a battery pack according to some embodiments. The battery pack comprises a cell stack arranged between a top terminal plate 321 and a bottom terminal plate (not shown) and at least partly enclosed at the sides by a frame structure 210 comprising electrical access points for any contacting means 140 as discussed in connection with FIGS. 1a-f and 2a-c. The contacting means 140 are connected at a first side of the stack, whereas the top terminal contact 322 and the bottom terminal contact 324 are supported by the side frame 210 at a second side of the stack. Thus, in some examples, three of the sides of the frame 210 may be configured to receive the tab-shaped contacting means 140, whereas the fourth side of the frame 210 may be configured to receive or support, inter alia, the terminal contacts 322, 324. It will however be appreciated that other configurations, shapes and designs are possible. For example, the cell stack (and hence the frame) may comprise other shapes than the generally quadrangular illustrated in the present, exemplary figures. The stack and/or frame may as well be provided with three sides, or more than four sides, depending on the application and base plate into which the battery pack is intended to be integrated.

While the top terminal contact 322 may be fixed to the side frame 210, it is appreciated that the top terminal plate 321 may move in the stacking direction due to expansion and contraction of the cell stack. A flexible connection between the top terminal plate 321 and the top terminal contact 322 may therefore be provided. The flexible connection, also referred to as a flexible busbar 325 or flexible conductor, may be configured to absorb relative mechanical movements between the (fixed) top terminal contact 322 and the (moving) top terminal plate 321. The flexible connection 325 may for example comprise a flexible or bendable material allowing for the flexible connection 325 to vary its length in the stacking direction. The flexibility, i.e., the ability of allow a relative movement between the terminals connected by the flexible connection 325, may be achieved by the mechanical configuration of the connection (such as folds or a braiding), and/or inherent properties of the material of the connection (such as a bendable or flexible material). In some examples, the connection 325 may comprise one or several sheets or wires that can be bent to allow the flexible connection 325 to vary its length or be formed as a braided conductor.

According to a fifth aspect, an electrode plate assembly is provided, which may be similarly configured as the disclosure of the first aspect. Thus, a plurality of cells may be arranged in a vertical stack, wherein each cell comprises a positive electrode plate, a negative electrode plate and a separator interposed between the electrode plates. Further, an intermediate layer may be arranged between neighbouring or adjacent cells of the stack, wherein the intermediate layer is configured to electrically connect the neighbouring cells to each other. The cells of the stack may hence be connected in series, which the electrical contact at least partly provided by means of the intermediate layer. Thus, the adjacent cells may be arranged such that the positive electrode plate of a first one of the neighbouring cells is facing the negative electrode plate of the other one of the neighbouring cells, and the intermediate layer arranged in electrical contact with the positive and the negative electrode plate.

The intermediate layer may for instance comprise an electrically conductive adhesive. Examples of electrically conductive adhesives, or glues, include an electrically conductive component suspended in a continuous phase material, or matrix. The electrically conductive component may for instance comprise particles of a metal such as silver, nickel or copper, or another electrical conductor such as e.g. graphite. The matrix, or adhesive component may in some examples comprise a polymer, such as epoxy, resin or silicone.

The intermediate layer may be provided as a continuous layer or a patterned layer covering a substantial part of the surface of the electrode plates and may in some example be applied by spray coating or laminated onto the cell. The thickness of the intermediate layer may for instance be of 10-100 μm, such as about 50 μm, depending on the cell stack configuration and the conductive properties of the intermediate layer.

Several effects may be achieved by providing the intermediate layer between adjacent cells. Firstly, the intermediate layer may be provided to join the cells electrically. The intermediate layer may be provided to fill out any irregularities between the adjoining surfaces and thereby improve the electrical contact. A pure mechanical contact, without any intermediate layer, may be more dependent on a low surface roughness to ensure a good electrical contact. The intermediate layer may thus serve the purpose of increasing the contact between the surfaces and compensate for any surface irregularities. Secondly, the intermediate layer may facilitate the mechanical bonding and increase the bonding strength between adjacent cells. In this way an improved mechanical contact may be achieved, reducing the need for a relatively high and constant compression along the stacking direction. The intermediate layer may thus assist in maintaining electrical and mechanical contact between adjacent cells also during expansion and contraction of the stack along the stacking direction. Further, the intermediate layer may assist in keeping the cells in a correct position also in a lateral direction, i.e., preventing the cells from being displaced orthogonally to the stacking direction.

FIG. 5 shows a top view of a cell 100 according to some embodiments, which may be similarly configured as any of the embodiments discussed above with reference to e.g. FIGS. 1a-f. Thus, the cell 100 may comprise a first electrode plate 110 and a second electrode plate (not shown), having a separator (not shown) interposed therebetween. As illustrated in FIG. 5, an intermediate layer 510 may be arranged on an outer surface of the cell 100, such as the surface of the first electrode plate 110 facing away from the separator. The intermediate layer 510 may for example be provided as a substantially continuous layer covering a major part of the outer surface of the cell 100. In the present example, the intermediate layer 510 may be formed by means of a spray coating tool 520.

1-36. (canceled)

37. An electrode plate assembly for a secondary battery module, the electrode plate assembly comprising:
a plurality of cells (100) arranged in a vertical stack (10); and
a plurality of contacting means (140) for electrical monitoring of the cells,
wherein:
each cell of the stack comprises a positive electrode plate (110), a negative electrode plate, and a separator;
the separator is interposed between the positive electrode plate and the negative electrode plate and configured allow ions to move between the positive electrode plate and the negative electrode plate;
each of the plurality of contacting means is electrically connected to at least one of the positive and negative electrode plates of a respective one of the cells and arranged to protrude laterally from a side edge (101, 102, 103) of the cell; and
the contacting means are distributed spatially along a width (W) of the stack.

38. The electrode plate assembly according to claim 37, wherein the contacting means are staggered along the vertical direction.

39. The electrode plate assembly according to claim 37, wherein each of the plurality of contacting means comprises a tab.

40. The electrode plate assembly according to claim 39, wherein the tab is attached to a contact point on the positive or negative electrode plate, or integrally formed with said electrode plate.

41. The electrode plate assembly according to claim 37, further comprising:
a plurality of sensors; and
a plurality of wireless transmitters;
wherein:
each of the plurality of sensors is coupled to a respective access point of a cell and configured to generate signal indicative of an operational parameter of said cell;
the access points are distributed spatially along a width (W) of the stack; and
each of the wireless transmitters is configured to transmit said signal.

42. The electrode plate assembly according to claim 41, wherein the operational parameter is at least one of a current, voltage and temperature of the cell.

43. The electrode plate assembly according to claim 37, further comprising a side frame part (210) configured to be arranged at a side of the stack, wherein the side frame part comprises a plurality of slots (215), and wherein each of the slots is configured to receive a respective contacting means as the side frame part is being arranged at the side of the stack.

44. The electrode plate assembly according to claim 43, wherein the slots are configured to allow the contacting means to extend through the side frame.

45. The electrode plate assembly according to claim 43, wherein a width of each of the slots, as seen in the stacking direction of the stack, is larger than a thickness of each of the contacting means, as seen in the stacking direction, thereby allowing for the contacting means to move along the stacking direction in response to the stack swelling and shrinking.

46. The electrode plate assembly according to claim 43, further comprising a plurality of contact pads (216) arranged adjacent to the slots, and wherein each of the contacting means is configured to be attached to a respective one of the contact pads.

47. The electrode plate assembly according to claim 46, wherein each of the contacting means is configured to be folded towards the respective contact pad.

48. The electrode plate assembly according to claim 43, wherein the side frame part comprises a printed circuit board (214).

49. The electrode plate assembly according to claim 43, wherein the side frame is a first side frame part, wherein the electrode plate assembly further comprises at least one second side frame part configured to be arranged at another side of the stack, and wherein the first side frame part and the at least one second sider frame part are configured to be assembled into a casing at least partly enclosing the stack.

50. The electrode plate assembly according to claim 37, wherein neighbouring cells of the stack are electrically interconnected by means of a direct mechanical contact between the positive electrode plate of a first one of the neighbouring cells and the negative electrode plate of the other one of the neighbouring cells.

51. The electrode plate assembly according to claim 37, further comprising a bottom terminal plate arranged below the stack and a top terminal plate arranged above the stack, wherein the bottom terminal plate is arranged in electrical contact with a bottom one of the cells and the top terminal plate is arranged in electrical contact with a top one of the cells.

52. The electrode plate assembly according to claim 51, wherein the bottom terminal plate is electrically connected to the bottom one of the cells by means of an electrically conducting intermediate layer, and wherein the top terminal plate is electrically connected to the top one of the cells by means of an electrically conducting intermediate layer.

53. The electrode plate assembly according to claim 51, further comprising a top terminal contact and a flexible busbar electrically connecting the top terminal contact to the top terminal plate, thereby allowing for the top terminal plate to move relative the top terminal contact in response to the stack swelling and shrinking.

54. The electrode plate assembly according to claim 51, further comprising:
a housing configured to accommodate the bottom terminal plate, the stack, and the top terminal plate, the housing comprising a base plate and a top cover configured to be attached to each other to form the housing; and
an elastic means configured to be arranged between the top cover and the top terminal plate to exert a compressing force on the stack in the stacking direction.

55. The electrode plate assembly according to claim 54, wherein the elastic means covers a major portion of the stack, as seen in the stacking direction.

56. The electrode plate assembly according to claim 54, wherein the elastic means is a foam plate or a spring plate.
